(19) United States
(12) Patent Application Publication
(10) Pub. No.: US 2026/0254889 A1
(43) Pub. Date: Aug. 27, 2026

(54) INFORMATION TRANSFER BETWEEN LAYERS IN A NETWORK

(71) Applicant: RAKUTEN MOBILE, INC., Tokyo (JP)

(72) Inventors: Ayajahamad BANKAPUR, Bangalore (IN); Ashish Ramesh GOOJAR, Tokyo (JP); Praveen KUMAR, Tokyo (JP)

(73) Assignee: RAKUTEN MOBILE, INC., Tokyo (JP)

(21) Appl. No.: 19/060,869

(22) Filed: Feb. 24, 2025

(51) Int. Cl. H04L 69/321; H04L 69/22; H04L 69/323

(52) U.S. Cl. CPC H04L 69/321; H04L 69/22; H04L 69/323

(57) ABSTRACT

Provided are apparatus, method, and device for automatically provisioning SRLG information from Layer 0/1 to Layer 3. According to example embodiments, the apparatus may be configured to: obtain Shared Risk Link Group (SRLG) information associated with a plurality of paths between a plurality of nodes in Layer 0/1 of an Open Systems Interconnection (OSI) model; embed the SRLG information in a control frame; and transmit the control frame with the embedded the SRLG information to a router implemented at Layer 3 of the OSI model.

### FIELD

The present disclosure relates to transfer of information between layers in a telecommunications network.

### BACKGROUND

The information disclosed in this background section is only for enhancement of understanding of the general background of the disclosure and should not be taken as an acknowledgement or any form of suggestion that this information forms the prior art already known to a person skilled in the art.

The Open Systems Interconnection (OSI) model in computer network refers to a model describing and defining a set of rules regarding how computer systems may communicate over a network across several abstraction layers.

In particular, the OSI model describes seven abstraction layers: an Application Layer (Layer 7), a Presentation Layer (Layer 6), a Session Layer (Layer 5), a Transport Layer (Layer 4), a Network Layer (Layer 3), a Data Link Layer (Layer 2), and a Physical Layer (Layer 1/Layer 0).

The seven layers describe the flow of data and network communication at different abstraction levels, from the physical transmission of bits across various mediums at the lowest abstraction level of the Physical Layer, to the data of an application at the highest abstraction level of the Application Layer.

### SUMMARY

Example embodiments of the present disclosure automatically provisioning SRLG information from Layer 0/1 to Layer 3. As such, example embodiments of the present disclosure allow for SRLG information to be provisioned to Layer 3 in an efficient, timely, and reliable manner, without requiring deployment of dedicated controlling elements.

According to example embodiments, an apparatus is provided. The apparatus may be configured to: obtain Shared Risk Link Group (SRLG) information associated with a plurality of paths between a plurality of nodes in Layer 0/1 of an Open Systems Interconnection (OSI) model; embed the SRLG information in a control frame; and transmit the control frame with the embedded the SRLG information to a router implemented at Layer 3 of the OSI model.

According to example embodiments, a method is provided. The method may include: obtaining Shared Risk Link Group (SRLG) information associated with a plurality of paths between a plurality of nodes in Layer 0/1 of an Open Systems Interconnection (OSI) model; embedding the SRLG information in a control frame; and transmitting the control frame with the embedded the SRLG information to a router implemented at Layer 3 of the OSI model.

According to example embodiments, a non-transitory computer-readable recording medium is provided. The non-transitory computer-readable recording medium may have recorded thereon instructions executable by an apparatus to cause the apparatus to perform a method including: obtaining Shared Risk Link Group (SRLG) information associated with a plurality of paths between a plurality of nodes in Layer 0/1 of an Open Systems Interconnection (OSI) model; embedding the SRLG information in a control frame; and transmitting the control frame with the embedded the SRLG information to a router implemented at Layer 3 of the OSI model.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example relationship between a Network Layer (Layer 3) and a Physical Layer (Layer 1/Layer 0) of an Open Systems Interconnection (OSI) model in the related art;

FIG. 2 illustrates an example system architecture, according to one or more example embodiments;

FIG. 3 illustrates a flow diagram of an example method for provisioning SRLG information, according to one or more example embodiments;

FIG. 4 illustrates a diagram of example components of a device for implementing one or more example embodiments; and

FIG. 5 illustrates a diagram of an example of implementation environment in which systems and/or method, described herein, may be implemented.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the present disclosure.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the International Telecommunication Union Telecommunication Standardization Sector (ITU-T) standard organization, the 3rd Generation Partnership Project (3GPP) standard organization, the European Telecommunications Standards Institute (ETSI) standard organization, the Open Radio Access Network (O-RAN) Alliance standard organization, and the like. For instance, the terms “GFP”, “PLI”, “SRLG”, and the like, as well as the associated features and operations, are to be interpreted as consistent with those specified in one or more technical specifications, unless described otherwise.

As described above, the OSI model describes the flow of data and network communication across seven abstraction levels. The present disclosure focuses on the communication between the Network Layer (Layer 3) and the Physical Layer (Layer 1/Layer 0).

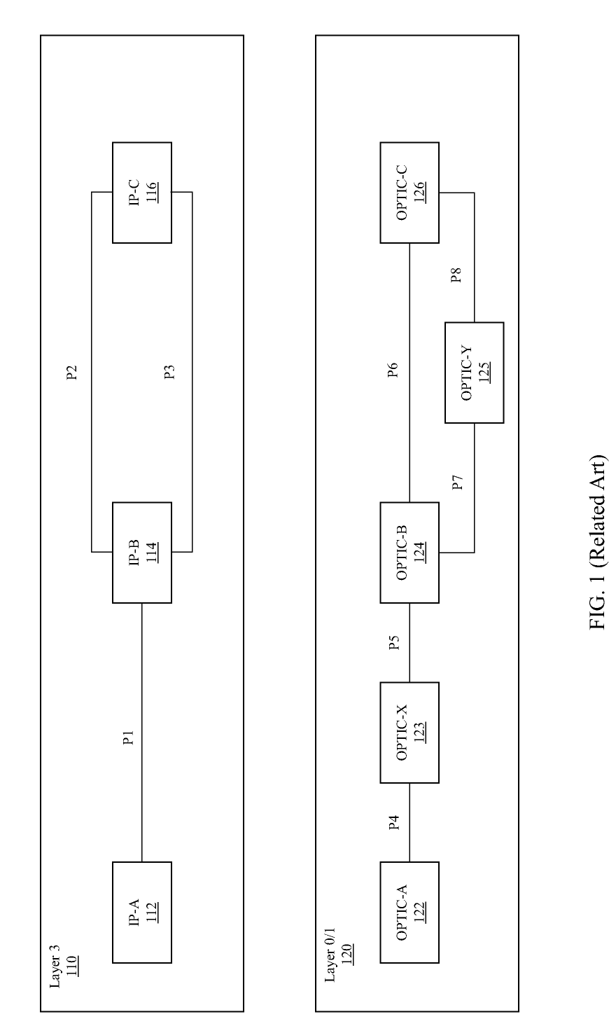

FIG. 1 illustrates an example relationship between a Network Layer (Layer 3) and a Physical Layer (Layer 1/Layer 0) of an Open Systems Interconnection (OSI) model in the related art. It is understood that the configuration illustrated in FIG. 1 is simplified for descriptive purpose, and is not intended to limit the scope of the present disclosure in any way. For example, the number of nodes can be any number, the number of paths can be any number, the paths can be between any nodes, and the like.

Layer 3 110 may refer to the Network Layer of the Open Systems Interconnection (OSI) model. Such Layer 3 110 may be managed by an administrator (operator) and may be comprised in an Internet Protocol (IP) Domain.

Layer 3 110 may include and define a plurality of paths describing the flow of information and data from one Layer 3 node to another Layer 3 node. In the example shown in FIG. 1, Layer 3 110 may include a plurality of Layer 3 nodes IP-A 112, IP-B 114, and IP-C 116 that are communicatively coupled to each other via a plurality of paths P1, P2, and P3. The information and data flowing in Layer 3 110 may be in the form of data packets. Further, the plurality of Layer 3 nodes may include at least one of routers and switches, while the plurality of paths between the plurality of Layer 3 nodes may include, for example, router links and the like.

Layer 0/1 120 may refer to the Physical Layer of the OSI model. Such Layer 0/1 120 may be managed by an administrator (different from the administrator of Layer 3 110), and may be comprised in an Optical Domain.

Layer 0/1 120 may include and define a plurality of paths describing the flow of information and data from one Layer 0/1 node to another Layer 0/1 node, as well as arrangements of the Layer 0/1 nodes in the network. In the example shown in FIG. 1, Layer 0/1 120 may include a plurality of Layer 0/1 nodes OPTIC-A 122, OPTIC-X 123, OPTIC-B 124, OPTIC-Y 125, and OPTIC-C 126 that are communicatively coupled to each other via a plurality of paths P4, P5, P6, P7, and P8. The information and data flowing in Layer 0/1 120 may be in the form of bits (e.g., 0s and 1s). Further, the plurality of Layer 0/1 nodes may include optical devices (e.g., hubs, repeaters, modems, and the like), while the plurality of paths between the plurality of Layer 0/1 nodes may include, for example, optic fibers and the like.

In this regard, one or more nodes of the plurality of Layer 3 nodes may be implemented on and correspond to one or more nodes of the plurality of Layer 0/1 nodes. In the example shown in FIG. 1, the IP-A 112, IP-B 114, and IP-C 116 from Layer 3 110 are implemented on and correspond to OPTIC-A 122, OPTIC-B 124, and OPTIC-C 126 from Layer 0/1 120, respectively.

Further, the communicational and connection relationships between the plurality of nodes from one layer may be reflected accordingly on the corresponding nodes from another layer. In particular, as shown in FIG. 1, IP-A 112 is communicatively coupled to IP-B 114 in Layer 3 110, which is reflected in Layer 0/1 120 where OPTIC-A 122 is communicatively coupled to OPTIC-B 124 via OPTIC-X 123. Similarly, IP-B 114 is communicatively coupled to IP-C 116 in Layer 3 110, which is reflected in Layer 0/1 120 where OPTIC-B 124 is communicatively coupled to OPTIC-C 126 directly and via OPTIC-Y 125.

The relationships between the nodes from Layer 3 110 and Layer 0/1 120 may define how data travels in different domains at different abstraction levels, where Layer 3 110 may represent a higher abstraction level in comparison to Layer 0/1 120. For example, when data is transmitted from IP-A 112 to IP-B 114 via path P1 in the form of data packets in Layer 3 110, said data is actually being transmitted from OPTIC-A 122 to OPTIC-X 123 via path P4 and then to OPTIC-B 124 via path P5 in the form of bits in Layer 0/1 120. In another example, when data is transmitted from IP-C 116 to IP-B 114 via path P3 in the form of data packets in Layer 3 110, said data is actually being transmitted from OPTIC-C 126 to OPTIC-Y 125 via path P8 and then to OPTIC-B 124 via path P7 in the form of bits in Layer 0/1 120. In further another example, when data is transmitted from IP-C 116 to IP-B 114 via path P2 in the form of data packets in Layer 3 110, said data is actually being transmitted from OPTIC-C 126 to OPTIC-B 124 via path P6 in the form of bits in Layer 0/1 120.

In this regard, since Layer 3 110 represents a higher abstraction level in comparison to Layer 0/1 120 and since Layer 3 110 and Layer 0/1 120 operate independently from each other, information related to the paths accessible at Layer 0/1 120 may not be readily accessible at Layer 3 110. One such information includes Shared Risk Link Group (SRLG) information.

The SRLG information may include information associated with paths (links) connecting the plurality of Layer 0/1 nodes, and may identify groups of paths (links) that share a common Layer 0/1 node and therefore share a risk of failure.

For example, SRLG information may include information associated with paths P4 to P8, and may identify, for example, that paths P5, P6, and P7 share a common Layer 0/1 node OPTIC-B 124 such that if OPTIC-B 124 fails then paths P5, P6, and P7 would also fail.

In another example, SRLG information may identify that paths P7 and P8 share a common Layer 0/1 node OPTIC-Y 125 such that if OPTIC-Y 125 fails then paths P7 and P8 would also fail. In this regard, since path P6 does not share the common Layer 0/1 node OPTIC-Y 125, path P6 may be identified and established as a backup path between OPTIC-B 124 and OPTIC-C 126.

Accordingly, the SRLG information may be utilized to identify and minimize the risk of a single point of failure affecting multiple paths.

In this regard, while the SRLG information is obtained and utilized at Layer 0/1 120, the SRLG information is not readily available to Layer 3 110, and Layer 3 110 may not be aware of risks information contained in the SRLG information.

For example, SRLG information may identify that paths P4 and P5 share a common Layer 0/1 node OPTIC-X 123 such that when OPTIC-X 123 fails, an administrator at Layer 0/1 120 would be aware that paths P4 and P5 would also fail and data cannot be transmitted between OPTIC-A 122 and OPTIC-B 124. However, since Layer 3 110 does not readily have access to the SRLG information and is not aware of OPTIC-X 123 and the risk associated with OPTIC-X 123, when OPTIC-X 123 fails, an administrator at Layer 3 110 would not be aware that information cannot be transmitted between IP-A 112 and IP-B 114, which may cause negative impact on the service.

Several methods have been proposed in the related art to facilitate provisioning of the SRLG information from Layer 0/1 to Layer 3.

One method in the related art involves coordination between the administrators from Layer 3 and Layer 0/1, where the administrator at Layer 0/1 would manually provide the SRLG information to the administrator at Layer 3, and the administrator at Layer 3 would then manually analyze the SRLG information to identify the risks and determine alternate/back up paths between nodes in Layer 3. However, such manual process is inefficient, time consuming, and error prone.

Another method in the related art involves deployment of dedicated controlling elements (e.g., controllers/path computation engines) at both layers, where such dedicated controlling elements perform operations to define paths in their respective layers and facilitate provision of SRLG information from Layer 0/1 to Layer 3. However, such process requires the dedicated controlling elements to be deployed and operational in both Layer 0/1 and Layer 3, which may not always be possible, reliable, or cost effective.

Accordingly, system, methods, devices, and the like, provided in the example embodiments of the present disclosure automatically provision SRLG information from Layer 0/1 to Layer 3.

According to example embodiments, an apparatus, which may correspond to an optical network element implemented at Layer 0/1 of an Open Systems Interconnection (OSI) model, may obtain Shared Risk Link Group (SRLG) information associated with a plurality of paths between a plurality of nodes in Layer 0/1, and embed the SRLG information in a control frame. Subsequently, the apparatus may transmit the control frame with the embedded the SRLG information to a router implemented at Layer 3 of the OSI mode.

Ultimately, example embodiments of the present disclosure automatically provision SRLG information from Layer 0/1 to Layer 3, which allows for SRLG information to be provisioned to Layer 3 in an efficient, timely, and reliable manner, without requiring deployment of dedicated controlling elements.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more embodiments, are provided in the following.

### Example System Architecture

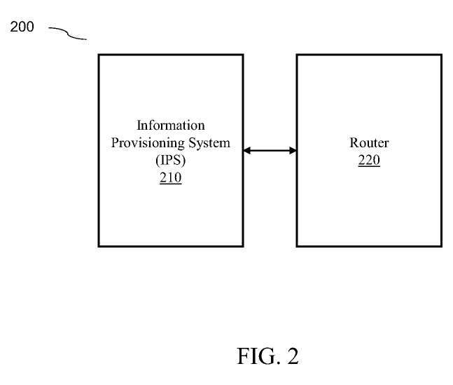

FIG. 2 illustrates an example system architecture 200, according to one or more example embodiments. As illustrated in FIG. 2, the system architecture 200 may include at least one Information Provisioning System (IPS) 210 and at least one Router 220. It is contemplated that the system architecture may include more/fewer components than illustrated, and/or may be configured in a different manner, without departing from the scope of the present disclosure.

The IPS 210 may include an apparatus, a system, a platform, a module, or the like, which may be configured to perform one or more operations or actions for provisioning of SRLG information. According to example embodiments, the IPS 210 may include an optical network element implemented at Layer 0/1 of the Open Systems Interconnection (OSI) model. The optical network element may include, for example, optical transport network terminal node.

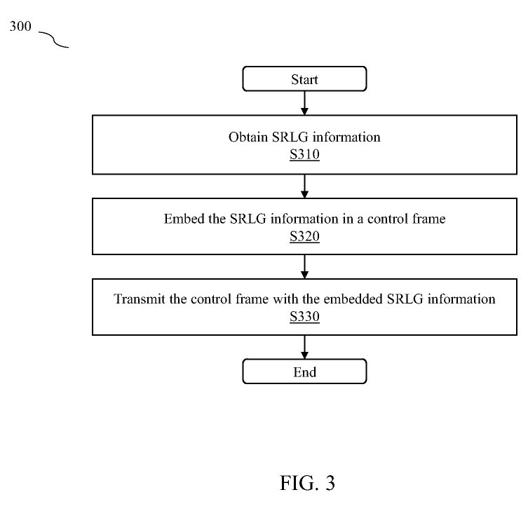

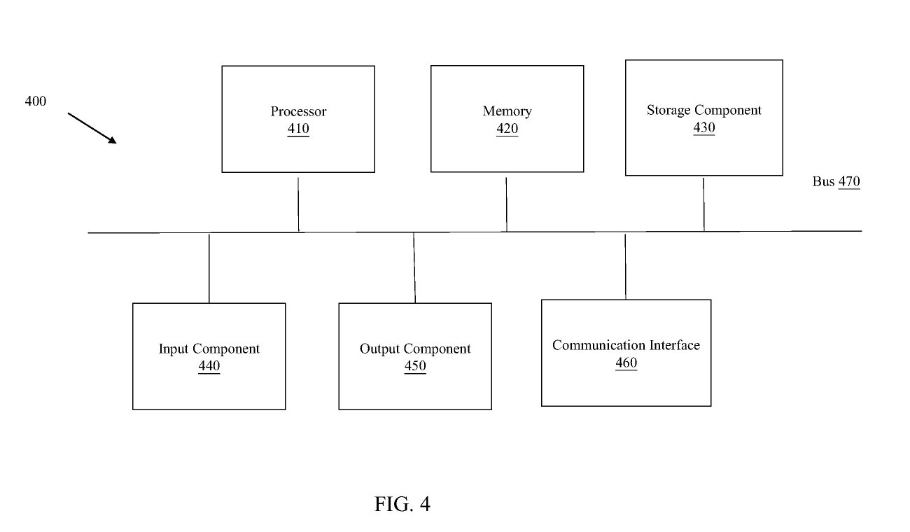

Example operations performable by the IPS 210 for provisioning of SRLG information are described below with reference to FIG. 3. Further, several example components which may be included in the IPS 210, according to one or more example embodiments, are described below with reference to FIG. 4.

The router 220 may include an Internet Protocol (IP) router implemented at Layer 3 of the OSI model. Further, the router 220 may be communicatively coupled to the IPS 210.

According to example embodiments, the router 220 may be configured to receive SRLG information from the IPS 210, and perform one or more operations associated with internet protocols at Layer 3 of the OSI model based on the SRLG information. For example, the router 220 may be configured to determine and create paths/routes for data packets to travel from a node to another at Layer 3 based on the SRLG information.

### Example Operations for Provisioning SRLG Information in the Present Disclosure

In the following, several example operations are performable by the apparatus of one or more example embodiments of the present disclosure are described with reference to FIG. 3.

FIG. 3 illustrates a flow diagram of an example method 300 for provisioning SRLG information, according to one or more example embodiments. One or more operations in method 300 may be performed by the apparatus of one or more example embodiments of the present disclosure. The apparatus may be configured to provision SRLG information. According to example embodiments, one or more operations in method 300 may be performed by the IPS 210.

As illustrated in FIG. 3, at operation S310, the apparatus may be configured to obtain Shared Risk Link Group (SRLG) information.

The SRLG information may be associated with a plurality of paths between a plurality of nodes in Layer 0/1 of the OSI model. In particular, the SRLG information may specify the plurality of paths between the plurality of nodes in Layer 0/1, as well as specify a least one group of paths from the plurality of paths, where the paths within the least one group of paths are associated with a common node in Layer 0/1.

Here, the Layer 0/1 may include a Physical Layer of the OSI model, and may be comprised in an Optical Domain. Further, the plurality of nodes in Layer 0/1 (i.e., plurality of Layer 0/1 nodes) may include optical devices. For example, the plurality of nodes in Layer 0/1 may include hubs, repeaters, modems, and the like.

According to example embodiments, the apparatus may be configured to obtain the SRLG information using any means. For example, the apparatus may be configured to obtain the SRLG information by: analyzing the network to identify the plurality of nodes in Layer 0/1 and the plurality of paths between the plurality of nodes in Layer 0/1; and identifying at least one group of paths from the plurality of paths that are associated with a common node in Layer 0/1. In another example, the apparatus may be configured to obtain the SRLG information by receiving the SRLG information from a user (e.g., manufacturer of optical devices, administrator of Layer 0/1, etc.)

It is understood that the SRLG information may include any additional information related to the plurality of paths between a plurality of nodes in Layer 0/1, such as SRLG number, User Network Interface (UNI) information, and the like. The method then proceeds to operation S320.

At operation S320, the apparatus may be configured to embed the SRLG information in a control frame.

The control frame may refer to a type of data frame used to manage information exchange between Layer 0/1 and Layer 3. According to example embodiments, the control frame may include a Generic Framing Procedure (GFP) control frame. Further, the GFP control frame may include a GFP core header specifying a value for Payload Length Indicator (PLI) as one of 1, 2, and 3.

Specifically, according to example embodiments, the apparatus may be configured to embed the SRLG information in the GFP control frame by, first, generating the GFP control frame. The GFP control frame may include a GFP core header and a payload. The GFP core header may include control information associated with the GFP as well as a Payload Length Indicator (PLI) specifying the length of the payload. According to example embodiments, the apparatus may configure the GFP core header to specify a value for PLI as one of 1, 2, and 3. The payload may include any kind of data that is to be transmitted from Layer 0/1 to Layer 3. For example, the payload may include data to be transmitted from Layer 0/1 to Layer 3 as defined in one or more technical specification (e.g., International Telecommunication Union Telecommunication Standardization Sector (ITU-T)).

Here, it is noted that GFP control frame with PLI set to 0 in the GFP core header may correspond to GFP idle frame.

Subsequently, the apparatus may be configured to include the SRLG information in the payload of the GFP control frame. Alternatively, the apparatus may be configured to include the SRLG information in the GFP core header of the GFP control frame.

It is understood that the apparatus may be configured to also perform any additional operations associated with the generation of the GFP frames, such as mapping/de-mapping of the GFP frames, and the like. Further, the GFP frames may be generated using any means. For example, the GFP frames may be generated via the use of GFP frame generators provided by optical device manufacturers. Such GFP frame generator may be implemented in an Application-Specific Integrated Circuit (ASIC), Field Programmable Gate Arrays (FPGAs), and the like.

According to example embodiments, the SRLG information may be embedded in the GFP control frame during GFP mapping/de-mapping. The method then proceeds to operation S330.

At operation S330, the apparatus may be configured to transmit the control frame with the embedded the SRLG information to a router implemented at Layer 3 of the OSI model. According to example embodiments, the router may include an Internet Protocol (IP) router in Layer 3.

Subsequently, in response to receiving the control frame, the router may process the control frame in order to obtain the SRLG information. The router may then perform one or more operations associated with internet protocols at Layer 3 of the OSI model based on the SRLG information. For example, the router 220 may be configured to update its routing logic for determining and creating paths/routes for data packets to travel from a node to another at Layer 3 based on the SRLG information.

It is understood that the router may be configured to also perform any additional operations associated with the reception and processing of the GFP frames, such as mapping/de-mapping of the GFP frames, and the like.

Upon performing operation S330, the method 300 may be ended or be terminated. Alternatively, method 300 may return to operation S310, such that the at least one processor may be configured to repeatedly perform, for at least a predetermined amount of time, the obtaining the SRLG information (at operation S310), the embedding the SRLG information (at operation S320), and the transmitting the control frame (at operation S330).

Accordingly, the above processes allow for SRLG information to be provisioned to Layer 3 in an efficient, timely, and reliable manner, without requiring deployment of dedicated controlling elements.

This enables information related to the nodes and paths in Layer 0/1 (i.e., SRLG information) to be synchronized between Layer 0/1 and Layer 3 in a simple manner that does not require dedicated controlling entities or manual operations by the administrators.

### Various Aspects of Embodiments

In view of the above, example embodiments of the present disclosure allow for SRLG information to be provisioned to Layer 3 in an efficient, timely, and reliable manner, without requiring deployment of dedicated controlling elements.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the system of the example embodiments as well as the operations associated therewith (e.g., one or more operations in FIG. 3, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 1 to FIG. 3 may be performed by the device. For instance, the one or more operations or methods may be performed by at least one processor of the device upon executing machine-readable instructions or computer-readable instructions stored in a memory or a storage component of the device.

FIG. 4 illustrates an embodiment of a device 400 for implementing one or more example embodiments. As shown in FIG. 4, the device 400 includes a processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 causes the processor 410 to perform one or more method steps of an embodiment described herein.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, an instruction device to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of device 400 in communication with one another.

Further, according to example embodiments, the device 400 may include one or more elements from the system architecture described above in relation to FIG. 2. For example, the device 400 may include the IPS 210.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

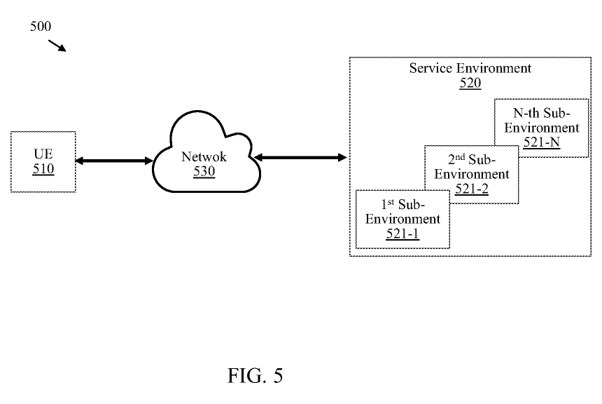

FIG. 5 is a diagram of an example of implementation environment 500 in which systems and/or method, described herein, may be implemented. The implementation environment 500 includes a UE (User equipment) 510, a service environment 520, and a network 530. The service environment 520 include one or more sub-environments 521. To illustrate this, FIG. 5 shows, for convenience, examples of a 1st sub-environment 521-1, a 2nd sub-environment 521-2, and an N-th sub-environment 521-N (where N is any natural number).

The UE 510 is connected to the network 530, and the network 530 is connected to the service environment 520. The connections may be wired, wireless, or a combination of both wired and wireless. The UE 510 and the service environment 520 are connected via the network 530.

The UE 510 is a device that communicates with the service environment 520. The UE 510 receives information from the service environment 520 and/or sends information to the service environment 520. Also, the UE 510 may generate and/or store information to be transmitted, as necessary. Also, the UE 510 may store and/or process information that is received, as necessary.

The example FIG. 5 refers to the “UE”. However, it should be understood by those skilled in the art that general terms such as “user device,” “terminal,” “terminal device,” “communication device,” and “communication terminal” can be used interchangeably with the term “UE.”

For example, the UE 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 520 is an environment that communicates with the UE 510 to provide one or more services. The service environment 520 receives information from the UE 510 and/or sends information to the UE 510. Also, the service environment 520 may generate and/or store information to be transmitted, as necessary. Also, the service environment 520 may store and/or process information that is received, as necessary. For example, the service environment 520 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 5 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment.”

The one or more services provided by the service environment 520 is not specifically limited and can be adjusted according to the embodiments. For example, the services may include a service that provides information to the UE 510, a service that stores information from the UE 510, or a service that performs processing based on information from the UE 510 and returns the results of the processing.

In an embodiment, the Service Environments 520 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 520 includes one or more devices, such as servers and network devices, which provide services or perform processes. The placement of these devices within the service environment 520 can be determined as appropriate. Additionally, if the service environment 520 includes one or more sub-environments 521, the placement of devices can be determined based on predetermined policies for each sub-environment 521. For example, devices related to the first service may be placed in the 1st sub-environment 521-1, and devices related to the second service may be placed in the 2nd sub-environment 521-2. In another example, devices expected to have a higher load than a predetermined threshold may be placed in the 1st sub-environment 521-1, while devices expected to have a lower load than the predetermined threshold may be placed in the 2nd sub-environment 521-2. In this way, specific devices can be placed in specific sub-environments 521. Conversely, each sub-environment 521 can be specialized for a particular purpose.

In an embodiment, all processes executed in a single service may run within a single service environment, or in multiple service environments. Multiple processes executed in a single service could be provided by different service environments.

The network 530 is a network that exchanges information between the UE 510 and the service environment 520. The network 530 includes one or more wired and/or wireless networks.

For example, the network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 530 can be a part of a network. For example, in a 5G network that includes a RAN, a transport network, and a core network, the network 530 can be at least one of the RAN, the transport network, or the core network. For example, the service environment 520 could be in the core network, in which case the network 530 could correspond to a network that is a combination of a RAN and a transport network and is part of the 5G network.

The number and arrangement of devices and networks shown in FIG. 5 are provided as an example. It should be understood that any changes that may be implemented by those skilled in the art, such as the addition or rearrangement of well-known devices or networks at the time of implementation, are included in this disclosure.

Various further respective aspects and features of embodiments of the present disclosure may be defined by the following items:

Item [1]: An apparatus that may be configured to: obtain Shared Risk Link Group (SRLG) information associated with a plurality of paths between a plurality of nodes in Layer 0/1 of an Open Systems Interconnection (OSI) model; embed the SRLG information in a control frame; and transmit the control frame with the embedded the SRLG information to a router implemented at Layer 3 of the OSI model.

Item [2]: The apparatus according to item [1], wherein the control frame may include Generic Framing Procedure (GFP) control frame.

Item [3]: The apparatus according to item [2], wherein the GFP control frame may include a GFP core header specifying a value for Payload Length Indicator (PLI) as one of 1, 2, and 3.

Item [4]: The apparatus according to one of items [1]-[3], wherein the apparatus may include an optical network element implemented at Layer 0/1.

Item [5]: The apparatus according to one of items [1]-[4], wherein the apparatus may be configured to embed the SRLG information in the control frame by generating a Generic Framing Procedure (GFP) control frame comprising a GFP core header and a payload, wherein the GFP core header may specify a value for Payload Length Indicator (PLI) as one of 1, 2, and 3.

Item [6]: The apparatus according to item [5], wherein the apparatus may be further configured to embed the SRLG information in the control frame by including the SRLG information in the payload of the GFP control frame.

Item [7]: The apparatus according to item [5], wherein the apparatus may be further configured to embed the SRLG information in the control frame by including the SRLG information in the GFP core header of the GFP control frame.

Item [8]: The apparatus according to one of items [1]-[7], wherein the plurality of nodes in Layer 0/1 may include optical devices.

Item [9]: A method that may include: obtaining Shared Risk Link Group (SRLG) information associated with a plurality of paths between a plurality of nodes in Layer 0/1 of an Open Systems Interconnection (OSI) model; embedding the SRLG information in a control frame; and transmitting the control frame with the embedded the SRLG information to a router implemented at Layer 3 of the OSI model.

Item [10]: The method according to item [9], wherein the control frame may include Generic Framing Procedure (GFP) control frame.

Item [11]: The method according to item [10], wherein the GFP control frame may include a GFP core header specifying a value for Payload Length Indicator (PLI) as one of 1, 2, and 3.

Item [12]: The method according to one of items [9]-[11], wherein the method may be performed by an optical network element implemented at Layer 0/1.

Item [13]: The method according to one of items [9]-[12], wherein the embedding the SRLG information in the control frame may include generating a Generic Framing Procedure (GFP) control frame comprising a GFP core header and a payload, wherein the GFP core header may specify a value for Payload Length Indicator (PLI) as one of 1, 2, and 3.

Item [14]: The method according to item [13], wherein the embedding the SRLG information in the control frame may further include including the SRLG information in the payload of the GFP control frame.

Item [15]: The method according to item [13], wherein the embedding the SRLG information in the control frame may further include including the SRLG information in the GFP core header of the GFP control frame.

Item [16]: The method according to one of items [9]-[15], wherein the plurality of nodes in Layer 0/1 may include optical devices.

Item [17]: A non-transitory computer-readable recording medium that may have recorded thereon instructions executable by an apparatus to cause the apparatus to perform a method including: obtaining Shared Risk Link Group (SRLG) information associated with a plurality of paths between a plurality of nodes in Layer 0/1 of an Open Systems Interconnection (OSI) model; embedding the SRLG information in a control frame; and transmitting the control frame with the embedded the SRLG information to a router implemented at Layer 3 of the OSI model.

Item [18]: The non-transitory computer-readable recording medium according to item [17], wherein the control frame may include Generic Framing Procedure (GFP) control frame.

Item [19]: The non-transitory computer-readable recording medium according to item [18], wherein the GFP control frame may include a GFP core header specifying a value for Payload Length Indicator (PLI) as one of 1, 2, and 3.

Item [20]: The non-transitory computer-readable recording medium according to one of items [17]-[19], wherein the apparatus may include an optical network element implemented at Layer 0/1.

It is understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
obtain Shared Risk Link Group (SRLG) information associated with a plurality of paths between a plurality of nodes in Layer 0/1 of an Open Systems Interconnection (OSI) model;
embed the SRLG information in a control frame; and
transmit the control frame with the embedded the SRLG information to a router implemented at Layer 3 of the OSI model.

2. The apparatus according to claim 1, wherein the control frame comprises Generic Framing Procedure (GFP) control frame.

3. The apparatus according to claim 2, wherein the GFP control frame comprises a GFP core header specifying a value for Payload Length Indicator (PLI) as one of 1, 2, and 3.

4. The apparatus according to claim 1, wherein the apparatus comprises an optical network element implemented at Layer 0/1.

5. The apparatus according to claim 1, wherein the apparatus is configured to embed the SRLG information in the control frame by generating a Generic Framing Procedure (GFP) control frame comprising a GFP core header and a payload, wherein the GFP core header specifies a value for Payload Length Indicator (PLI) as one of 1, 2, and 3.

6. The apparatus according to claim 5, wherein the apparatus is further configured to embed the SRLG information in the control frame by including the SRLG information in the payload of the GFP control frame.

7. The apparatus according to claim 5, wherein the apparatus is further configured to embed the SRLG information in the control frame by including the SRLG information in the GFP core header of the GFP control frame.

8. The apparatus according to claim 1, wherein the plurality of nodes in Layer 0/1 comprises optical devices.

9. A method comprising:
obtaining Shared Risk Link Group (SRLG) information associated with a plurality of paths between a plurality of nodes in Layer 0/1 of an Open Systems Interconnection (OSI) model;
embedding the SRLG information in a control frame; and
transmitting the control frame with the embedded the SRLG information to a router implemented at Layer 3 of the OSI model.

10. The method according to claim 9, wherein the control frame comprises Generic Framing Procedure (GFP) control frame.

11. The method according to claim 10, wherein the GFP control frame comprises a GFP core header specifying a value for Payload Length Indicator (PLI) as one of 1, 2, and 3.

12. The method according to claim 9, wherein the method is performed by an optical network element implemented at Layer 0/1.

13. The method according to claim 9, wherein the embedding the SRLG information in the control frame comprises generating a Generic Framing Procedure (GFP) control frame comprising a GFP core header and a payload, wherein the GFP core header specifies a value for Payload Length Indicator (PLI) as one of 1, 2, and 3.

14. The method according to claim 13, wherein the embedding the SRLG information in the control frame further comprises including the SRLG information in the payload of the GFP control frame.

15. The method according to claim 13, wherein the embedding the SRLG information in the control frame further comprises including the SRLG information in the GFP core header of the GFP control frame.

16. The method according to claim 9, wherein the plurality of nodes in Layer 0/1 comprises optical devices.

17. A non-transitory computer-readable recording medium having recorded thereon instructions executable by an apparatus to cause the apparatus to perform a method comprising:
obtaining Shared Risk Link Group (SRLG) information associated with a plurality of paths between a plurality of nodes in Layer 0/1 of an Open Systems Interconnection (OSI) model;
embedding the SRLG information in a control frame; and
transmitting the control frame with the embedded the SRLG information to a router implemented at Layer 3 of the OSI model.

18. The non-transitory computer-readable recording medium according to claim 17, wherein the control frame comprises Generic Framing Procedure (GFP) control frame.

19. The non-transitory computer-readable recording medium according to claim 18, wherein the GFP control frame comprises a GFP core header specifying a value for Payload Length Indicator (PLI) as one of 1, 2, and 3.

20. The non-transitory computer-readable recording medium according to claim 17, wherein the apparatus comprises an optical network element implemented at Layer 0/1.
